(19) United States
(12) Patent Application Publication
(10) Pub. No.: US 2009/0278949 A1
(43) Pub. Date: Nov. 12, 2009

(54) CAMERA SYSTEM AND METHOD FOR PROVIDING INFORMATION ON SUBJECTS DISPLAYED IN A CAMERA VIEWFINDER

(76) Inventors: David Michael McMahan, Raleigh, NC (US); L. Scott Bloebaum, (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/115,605

(22) Filed: May 6, 2008

(51) Int. Cl. H04N 5/228; G06K 9/72

(52) U.S. Cl. 348/222.1; 382/229; 348/E05.031

(57) ABSTRACT

An improved camera system for manipulating multiple images of similar subject matter is described. Embodiments of the present disclosure provide for the analysis of subject matter depicted in the viewfinder of the camera. Subjects previously photographed may be recognized automatically. Before or after a picture is taken, for each recognized subject, a user may be presented with existing images of the subject already stored in a memory or database. The user may then invoke one or more manipulation operations as to the various images of the common subject. For example, a user may retain the new image in addition to previously stored images, discard the new and/or previously stored images, transfer the new and/or previously stored images to third parties, and the like.

### TECHNICAL FIELD OF THE INVENTION

The technology of the present disclosure relates generally to digital photography, and more particularly to a camera system and method that provides a user with information regarding subjects displayed in a camera viewfinder.

### DESCRIPTION OF THE RELATED ART

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera for taking still photographs and/or video images, an Internet browser for accessing news and information, an audiovisual media player, a messaging device (text, audio, and/or visual messages), a gaming device, a personal organizer, and have other functions as well.

Digital camera functions in particular, whether as stand-alone digital cameras or as part of multifunction devices, are common. Their large storage capacity and ease of use permits the collection of a large number of images. In addition, because camera functionality is often provided in multifunction devices, such as mobile telephones, it is common for the camera function to be used even when the desire to take a photograph may not be expected.

As a result, the potential for taking redundant images has increased. A user may not always be aware of the content of relevant collections of numerous images previously photographed, and it may be time consuming to review a library of such stored digital images to determine whether a similar photograph already exists. Taking time to review a large collection of digital images may result in a lost opportunity if a subject were to move or conditions otherwise change. On the other hand, acquiring redundant images undesirably consumes memory resources that often must be shared among many functions of the device, and it likewise may be difficult to sift through and sort stored images to discard duplicate content after the fact.

### SUMMARY

To improve the consumer experience with portable electronic devices having a digital camera function, there is a need in the art for an improved camera system for manipulating multiple images of similar subject matter, including, for example, reducing the propensity for taking and storing redundant images. Embodiments of the present disclosure provide for the analysis of subject matter depicted in the viewfinder of a camera. Subjects, including people and objects, previously photographed may be recognized automatically. Before or after a picture is taken, for each recognized subject, a user may be presented with existing images of the subject already stored in a memory or database. The user may then invoke one or more manipulation operations as to the various images of the common subject. For example, a user may retain the new image in addition to previously stored images, discard the new and/or previously stored images, transmit the new and/or previously stored images to third parties or particular database locations, as well as other manipulation operations.

Therefore, according to one aspect of the disclosure, an electronic device comprises a camera assembly for capturing an image, and a controller. The controller is configured to perform picture recognition on the captured image to recognize at least one subject within the captured image, and configured to compare the recognized subject from the captured image to a plurality of stored images to identify at least one stored image that contains the at least one recognized subject from the captured image. The electronic device further comprises an input interface for receiving an input command to manipulate at least one of the captured image or an identified stored image, wherein the controller executes the received manipulation command.

According to one embodiment of the electronic device, the electronic device further comprises a viewfinder for displaying the captured image.

According to one embodiment of the electronic device, the controller is configured to perform picture recognition by applying pattern matching against a reference to recognize one or more subjects in the captured image.

According to one embodiment of the electronic device, the electronic device further comprises a location/orientation assembly for gathering location data, wherein the controller is further configured to perform picture recognition by comparing the gathered location data to location information contained in a location database to recognize a subject in the captured image.

According to one embodiment of the electronic device, the location/orientation assembly comprises at least one of a position data receiver, an altimeter, a compass, or an accelerometer.

According to one embodiment of the electronic device, the electronic device further comprises a location/orientation assembly for gathering location data, wherein the controller is further configured to perform picture recognition by comparing the gathered location data to location information contained in metadata of the stored images to recognize a subject in the captured image.

According to one embodiment of the electronic device, the electronic device further comprises a storage device containing the plurality of stored images.

According to one embodiment of the electronic device, the electronic device is a mobile telephone.

According to one embodiment of the electronic device, the manipulation command is at least one of saving the captured image, deleting the captured image or an identified stored image, transmitting the captured image or an identified stored image, or viewing an identified stored image.

According to one embodiment of the electronic device, the controller is further configured to incorporate subject information relating to the recognized subject into metadata associated with the captured image, and configured to compare metadata associated with the recognized subject of the captured image to metadata associated with each of the plurality of stored images to identify at least one stored image that contains the recognized subject.

Another aspect of the invention is a server for communicating with an electronic device having a camera assembly for capturing an image. The server comprises an image database containing a plurality of stored images and a controller. The controller is configured to perform picture recognition on the captured image to recognize at least one subject within the captured image, and configured to compare the recognized subject of the captured image to the plurality of stored images to identify at least one stored image that contains a recognized subject. The server receives a command from a user of the portable electronic device to manipulate at least one of the captured image or an identified stored image, and the controller executes the received manipulation command.

According to one embodiment of the server, the controller is configured to perform picture recognition by applying pattern matching against a reference to recognize the subject in the captured image.

According to one embodiment of the server, the server further comprises a location database containing location information relating to a plurality of locations, wherein the server receives location data from the portable electronic device regarding a user's location. The controller is further configured to perform picture recognition by comparing the location data received from the electronic device and location information contained in the location database to recognize the subject in the captured image.

According to one embodiment of the server, the controller is further configured to incorporate subject information relating to the recognized subject into metadata associated with the captured image, and configured to compare metadata associated with the recognized subject of the captured image to metadata associated with each of the plurality of stored images to identify at least one stored image that contains the recognized subject.

Another aspect of the invention is a method of operating a camera function comprising the steps of capturing an image, performing picture recognition to recognize a subject in the captured image, comparing the recognized subject of the captured image to a plurality of stored images to identify at least one stored image that contains the recognized subject, and manipulating at least one captured image or an identified stored image.

According to one embodiment of the method, the method further comprises displaying the captured image.

According to one embodiment of the method, performing picture recognition comprises applying pattern matching to a reference to recognize the subject in the captured image.

According to one embodiment of the method, performing picture recognition further comprises gathering location data relating to the captured image and comparing the location data to location information in a location database to recognize the subject in the captured image.

According to one embodiment of the method, the method further comprises incorporating subject information relating to the recognized subject into metadata associated with the captured image, wherein the comparing step includes comparing the metadata associated with the recognized subject of the captured image to metadata associated with each of the plurality of stored images to identify the at least one stored image that contains the recognized subject.

According to one embodiment of the method, the manipulating step comprises photographing the captured image by creating a photograph file of the captured image and storing the photograph file.

According to one embodiment of the method, the manipulating step comprises at least one of saving the captured image, deleting the captured image or an identified stored image, transmitting the captured image or an identified stored image, or viewing an identified stored image.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic front view of a mobile telephone as an exemplary electronic device that includes a representative camera assembly.

FIG. 2 is a schematic rear view of the mobile telephone of FIG. 1.

FIG. 3 is a schematic block diagram of operative portions of the mobile telephone of FIG. 1.

FIG. 4 is a schematic diagram of a communications system in which the mobile telephone may operate.

FIG. 5 is a schematic block diagram of operative portions of an exemplary picture recognition server that is part of the communications system of FIG. 4.

FIG. 6 depicts an overview of an exemplary method of operating a camera function that employs picture recognition.

FIG. 7A depicts an exemplary image as may be depicted in a camera viewfinder.

FIG. 7B depicts an exemplary graphical user interface overlaid upon the exemplary image of FIG. 7A.

FIGS. 8A and 8B depict an exemplary graphical user interface for use in connection with the mobile telephone of FIG. 1.

### DETAILED DESCRIPTION OF EMBODIMENTS

The present disclosure provides a digital camera system that may automatically recognize subjects depicted within the viewfinder of the camera. In certain embodiments, subjects depicted or displayed in the viewfinder are referred to as being “captured” by the camera assembly. In this context, the term capture refers to a temporary freezing or temporary storage of the image so that the image may be viewed in the viewfinder or display associated with the camera. A captured image may be placed or stored in an image buffer, a volatile RAM-type memory, or similar storage medium suitable for a transient display state. A captured image, therefore, may be contrasted to a stored photograph file (e.g., a JPEG or similar file) that may be stored in a more permanent memory. A captured image may be that of a real-time subject at which the camera is being pointed, the subject being displayed in the viewfinder. A captured image also may be derived from a more permanently stored file, such as when a user temporarily views a stored image in the display of the camera.

A captured image, therefore, provides a means of temporarily accessing or displaying an image for further analysis, including subject recognition as described below. Once a subject in a captured image is recognized, a user may be presented with stored images of the same or similar subject matter, which may aid the user in manipulating multiple or redundant images containing overlapping subject matter.

For example, subjects may be “dynamic” or “static”. As used herein, dynamic subjects would tend to be subjects that move or change orientation readily. Common examples of dynamic subjects may include people, pets and other animals, vehicles, and the like. As used herein, static subjects would tend to be subjects that are substantially stationary over a long period of time. Common examples of static subjects may include such subjects as buildings, monuments, memorials and other man-made edifices and structures, natural landmarks like mountains, lakes, natural wonders, etc., and combinations thereof. It will be appreciated that an image to be photographed depicted within the viewfinder of the camera may contain both dynamic and static subjects, and perhaps more than one of each category. The camera system described herein may apply pattern matching and image recognition techniques to recognize static and dynamic subjects. In addition, location and orientation information may be gathered to provide additional recognition information as to static subjects. The recognition information may be used to recognize one or more subjects depicted in the viewfinder of the camera.

Once the camera system has recognized a subject or subjects in the viewfinder of the camera, the camera system may identify stored images containing the same, similar, or overlapping subject matter. References to stored images may be presented to the user for selection and/or viewing. The user may then perform one or more of a variety of operations to manipulate the image depicted in the viewfinder, and/or manipulate the related stored images. For example, a user may photograph and store the image depicted in the viewfinder (the “viewfinder image”) in a photograph file, delete the viewfinder image, delete one or more of the stored images, reorganize the viewfinder and/or stored images, email or otherwise transmit the viewfinder and/or stored images to others, and/or perform other manipulation operations as well. In this manner, a user may more efficiently handle multiple images related to the same or similar subject matter, including the ability to discard duplicate or similar images to save memory space, if desired.

Embodiments of the camera system and related methods will now be described with reference to the drawings, wherein like reference numerals are used to refer to like elements throughout. It will be understood that the figures are not necessarily to scale.

In the illustrated embodiments, the camera system is embodied as a digital camera assembly that is made part of a mobile telephone. It will be appreciated that aspects of the camera system are not intended to be limited to the context of a mobile telephone and may relate to any type of appropriate electronic device, examples of which include a stand-alone digital camera, a media player, a gaming device, or similar. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any communication apparatus or the like.

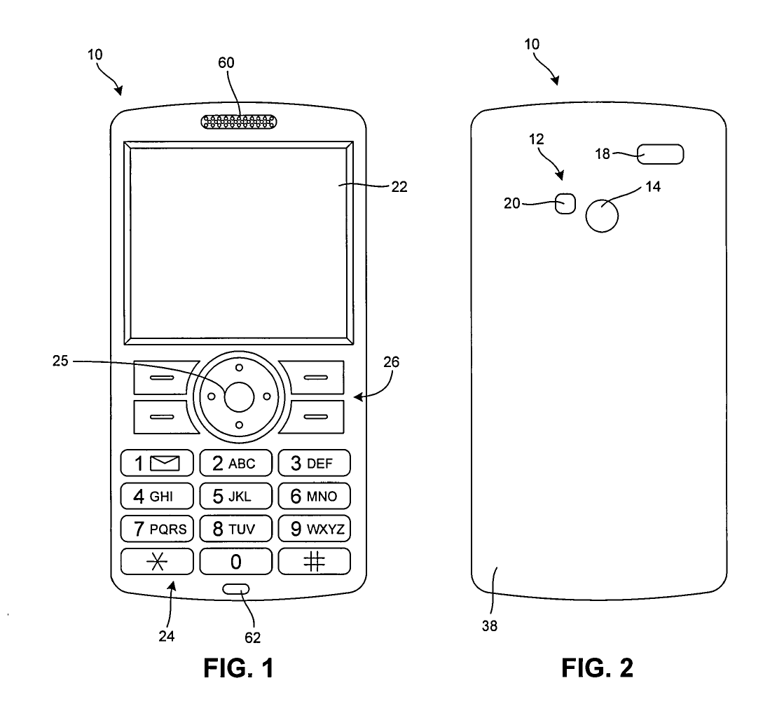

FIGS. 1 and 2 are schematic front and rear views respectively of an electronic device 10. The illustrated electronic device 10 is a mobile telephone, but, as stated above, may be any portable electronic device that has a camera function. The exemplary mobile telephone is depicted as having a “block” or “brick” configuration, although the mobile telephone may have other configurations, such as, for example, a clamshell, pivot, swivel, and/or sliding cover configuration as are known in the art.

As seen in FIG. 2, the electronic device 10 includes a camera assembly 12 for taking digital still pictures and/or digital video clips. Although the description herein is made primarily in the context of taking digital still photographs, it will be appreciated that the concepts also may be applied to moving video images.

The camera assembly 12 may contain imaging optics 14 to focus light from a scene within the field-of-view of the camera assembly 12 onto a sensor 16 (not shown in this figure). The sensor converts the incident light into image data. The imaging optics 14 may include various optical components, such as a lens assembly and components that supplement the lens assembly (e.g., a protective window, a filter, a prism, and/or a mirror). The imaging optics 14 may be associated with focusing mechanics, focusing control electronics (e.g., a multi-zone autofocus assembly), optical zooming mechanics, and the like. Other camera assembly 12 components may include a flash 18 to provide supplemental light during the capture of image data for a photograph, and a light meter 20.

Referring again to FIG. 1, a display 22 may function as an electronic viewfinder for the camera assembly 12. In addition, as part of an interactive user interface, a keypad 24 and/or buttons 26 may be associated with aspects of the camera system 12. For example, one of the keys from the keypad 24 or one of the buttons 26 may be a shutter key that the user may depress to command the taking of a photograph. One or more keys also may be associated with entering a camera mode of operation, such as by selection from a conventional menu or by pushing a dedicated button for the camera function. The camera assembly may possess other features, such as, for example, an optical viewfinder (not shown), and any other components commonly associated with digital cameras.

Typically, the display 22, which may function as the viewfinder of the camera assembly, is on an opposite side of the electronic device 10 from the imaging optics 14. In this manner, a user may point the camera assembly 12 in a desired direction and view a representation of the field-of-view of the camera assembly 12 on the display 22. The field-of-view of the camera assembly 12 may be altered with characteristics of the imaging optics 14 and optical settings, such as an amount of zoom. The camera field-of-view may be displayed in the camera viewfinder (display 22 in this embodiment), which may then be photographed.

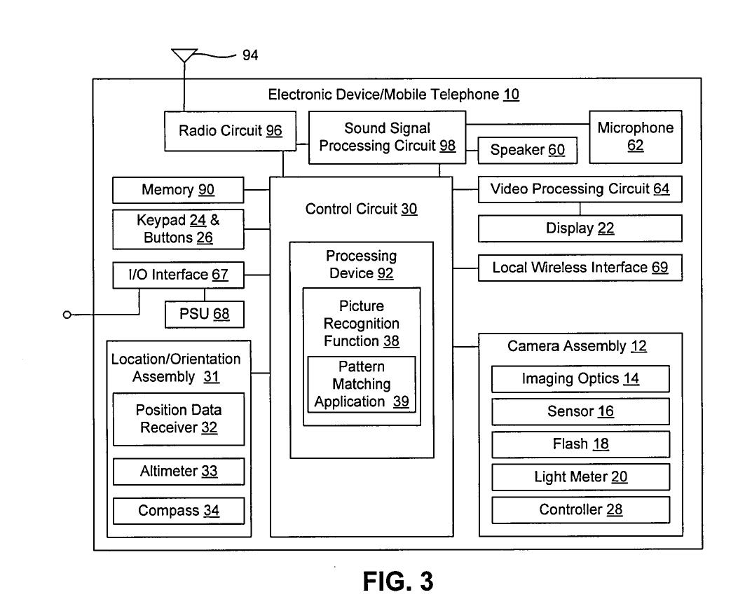

FIG. 3 is a schematic block diagram of operative portions of the electronic device/mobile telephone 10. The electronic device 10 may include the camera assembly 12, as described above, having imaging optics 14, sensor 16, flash 18, and light meter 20. Another component of the camera assembly 12 may be an electronic controller 28 that controls operation of the camera assembly 12. The controller 28 may be embodied, for example, as a processor that executes logical instructions that are stored by an associated memory, as firmware, as an arrangement of dedicated circuit components, or as a combination of these embodiments. Thus, methods of operating the camera assembly 12 may be physically embodied as executable code (e.g., software) that is stored on a machine readable medium or may be physically embodied as part of an electrical circuit. In another embodiment, the functions of the electronic controller 28 may be carried out by a control circuit 30 that is responsible for overall operation of the electronic device 10. In this case, the controller 28 may be omitted. In another embodiment, camera assembly 12 control functions may be distributed between the controller 28 and the control circuit 30.

The electronic device 10 also may include a location/orientation assembly 31 that may include various components for determining the location and orientation of the electronic device 10. For example, the location/orientation assembly 31 may include a position data receiver 32, such as a global positioning system (GPS) receiver, Galileo satellite system receiver or the like. The position data receiver 32 may be involved in determining the location of the electronic device 10. The location data received by the position data receiver 32 may be processed to derive a location value, such as coordinates expressed using a standard reference system (e.g., the world geodetic system or WGS). Also, assisted-GPS (or A-GPS) may be used to determine the location of the electronic device 10. A-GPS uses an assistance server, which may be implemented with a server of a communications network in which the electronic device 10 operates. As is known in the art, the assistance server processes location related data and accesses a reference network to speed location determination and transfer processing tasks from the electronic device 10 to the server.

Location/orientation assembly 31 may include various other components for determining the location and orientation of the electronic device 10. For example, such other components may include an altimeter 33 for determining the altitude of the electronic device 10, such as a height value relative to sea level. Another component may be a compass 34, such as a magnetic, electronic, or digital compass. The compass 34 may generate information regarding the direction in which the camera assembly 12 is pointed. The direction information may include a compass direction (e.g., north, east, west and south, and any direction between these four references) and an elevation (e.g., a positive or negative angle valve with respect to horizontal). Various other components (not shown) may be incorporated to provide location, altitude, and/or directional information, such as, for example, range finders, accelerometers or inclinometers, an electronic level, and/or others known in the art.

The electronic device 10 may further include a picture recognition function 38 that is configured to recognize the subject matter depicted within the viewfinder of the camera assembly 12. Additional details and operation of the picture recognition function 38 will be described in greater detail below. The picture recognition function 38 may be embodied as executable code that is resident in and executed by the electronic device 10. The function 38, for example, may be executed by a processing device 92 located in and configured as part of the control circuit 30. In one embodiment, the picture recognition function 38 may be a program stored on a computer or machine readable medium. The picture recognition function 38 may be a stand-alone software application or form a part of a software application that carries out additional tasks related to the electronic device 10.

It will be apparent to a person having ordinary skill in the art of computer programming, and specifically in application programming for mobile telephones or other electronic devices, how to program the electronic device 10 to operate and carry out logical functions associated with the picture recognition function 38. Accordingly, details as to specific programming code have been left out for the sake of brevity. Function 38 may operate pursuant to content-based image retrieval techniques to perform recognition functions described below. Generally, such techniques as are known in the art involve analyzing images based on content such as colors, shapes, textures, and/or similar information that may be derived from the image. Also, while the function 38 may be executed by respective processing devices in accordance with an embodiment, such functionality could also be carried out via dedicated hardware or firmware, or some combination of hardware, firmware and/or software.

The picture recognition function 38 may include pattern matching application 39. The pattern matching application 39 may perform various image recognition techniques to match subjects depicted in the camera viewfinder against a reference. The reference may be a stored image, including, for example, an image stored within a memory 90 located within the electronic device 10, stored on a removable storage medium such as a memory card, or located within an external database. The stored images also may be distributed over a variety of storage media. The image recognition techniques, may include, for example, face recognition of human subjects captured in the viewfinder. Similar techniques may be used to match or recognize various other subjects, examples of which are described above. The pattern matching techniques, therefore, may be applied to dynamic and static subjects that may be depicted in the viewfinder. The picture recognition function 38 may combine pattern matching with location and orientation information gathered by the location/orientation assembly 31. By combining pattern matching with location and orientation information, the picture recognition function 39 may more efficiently and completely recognize subject matter depicted in the viewfinder.

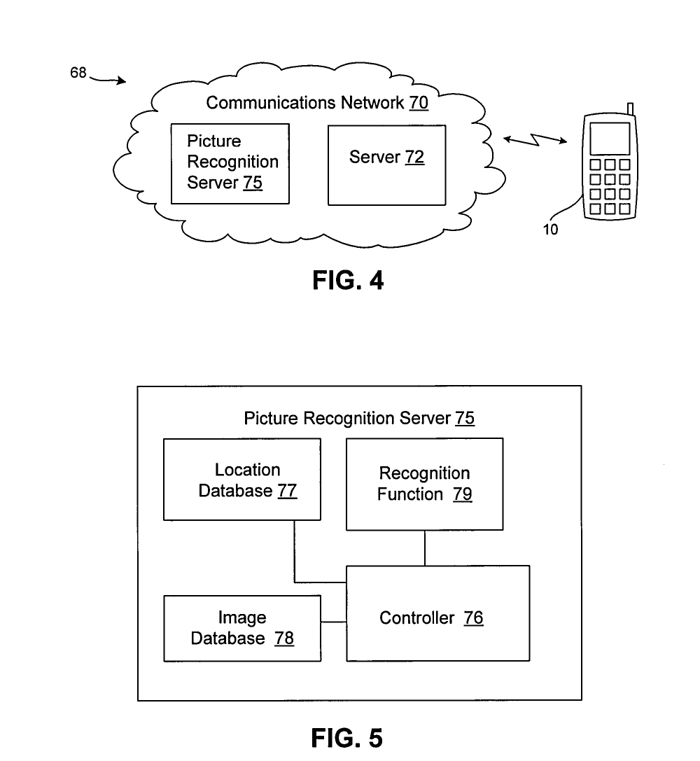

Referring to FIG. 4, the electronic device (mobile telephone) 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software.

Communications network 70 also may include a picture recognition server 75. FIG. 5 represents a functional block diagram of operative portions of an exemplary picture recognition server 75. The picture recognition server may include a controller 76 for carrying out and coordinating the various functions of the server. The picture recognition server 75 also may include a location database 77 for storing location data regarding various locations. The picture recognition server also may include an image database 78 for storing a plurality of digital images. As further described below, the location database 77 and/or the image database 78 may aid in the recognition of subjects within the camera viewfinder of a networked electronic device.

Picture recognition server 75 also may include a picture recognition function 79, which may be similar to the picture recognition function 38 located within the electronic device 10. As such, picture recognition function 79 may be used to aid in recognizing the subjects depicted within a viewfinder of a camera. The picture recognition function 79 also may be embodied as executable code that is resident in and executed by the picture recognition server 75. The function 79, for example, may be executed by the controller 76. The picture recognition function 79 may be a stand-alone software application or form a part of a software application that carries out additional tasks related to the server 75. It will be apparent to a person having ordinary skill in the art of computer programming, and specifically in application programming for servers or other electronic devices, how to program the server 75 to operate and carry out logical functions associated with the picture recognition function 79. Accordingly, details as to specific programming code have been left out for the sake of brevity. Also, while the function 79 may be executed by respective processing devices in accordance with an embodiment, such functionality could also be carried out via dedicated hardware or firmware, or some combination of hardware, firmware and/or software. The operation of function 79 also may be divided between the server and a client electronic device, such as the function 38 of the camera assembly reference above.

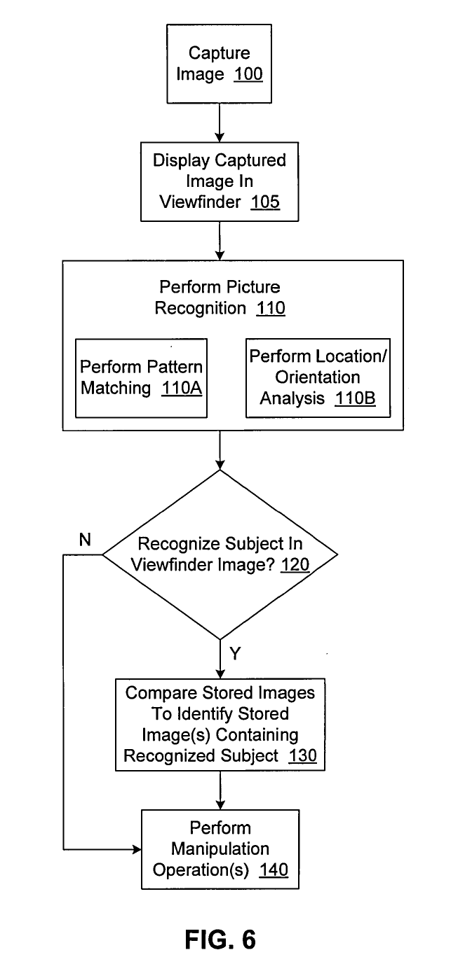

FIG. 6 depicts an overview of an exemplary method of operating a camera function that employs the picture recognition of the present disclosure. Additional details regarding each step are provided in connection with the examples below. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 100 in which an image as represented by the field-of-view of the camera assembly is captured by a camera assembly. At step 105, the captured image may be displayed in a camera viewfinder. At step 110, a picture recognition function may be executed. The picture recognition function may include pattern matching (step 110A), such as, for example, face recognition or other visual image recognition techniques. Picture recognition also may include a location/orientation analysis (step 110B), which provides location data about the user's location and point-of-view or orientation of the camera. As an exemplary use of location/orientation data, the data may constrain the number of images to which the pattern matching step is applied. For example, the pattern matching may be limited to images taken within some distance of the current location. The images used for pattern-matching could be constrained further, but in the same manner, by using the orientation/inclination information along with the location. Additional constraints may be based on the respective angles (or fields) of view of the captured and stored pictures. Other uses of the location orientation data may be employed without departing from the scope of the invention.

Based on the pattern matching and/or location data, at step 120 a determination may be made as to whether a subject depicted within the viewfinder is recognized. If not, then the method may skip to step 140, at which a user may command the performance of one or more manipulation operations. For example, the user may take a photograph of the image depicted in the viewfinder by storing the image in a photograph file, discard the image depicted in the viewfinder, or transmit the image depicted in the viewfinder to another. If, however, at step 120 a subject depicted within the viewfinder is recognized, at step 130 the recognized subject in the captured image may be compared to a plurality of stored images to identify any stored images containing the same, similar, or overlapping subject matter. The method may then proceed to step 140, at which the user may command the performance of one or more manipulation operations. In this situation, the user may carry out one or more of the foregoing manipulation operations on the image depicted in the viewfinder, and also on the stored images containing the recognized subject. For example, a user may view an indentified stored image, delete an identified stored image in favor of the captured image depicted in the viewfinder, reorganize the images, transmit one or more of the images, and/or other operations as well.

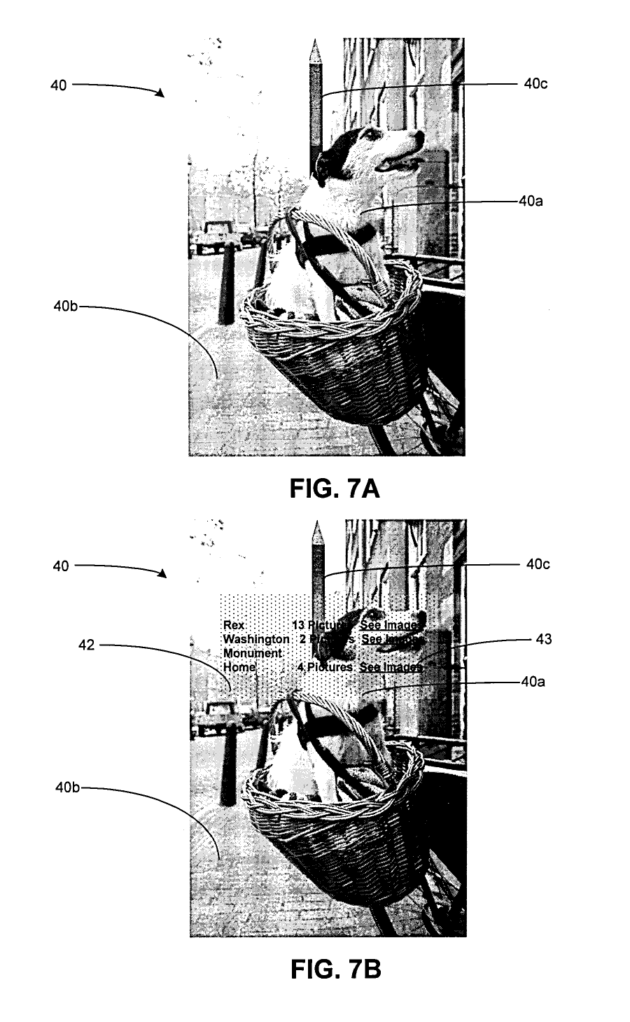

The method of operating a camera function may be described in more detail with reference to an exemplary image to be photographed. For example, FIG. 7A depicts an exemplary image 40 as may be depicted in a digital camera viewfinder, such as the display 22 of the electronic device 10 described above. In this example, a user's pet dog “Rex” is one subject 40a in the photograph. Rex is an example of a dynamic subject because he has a tendency to be in different locations at different times. As a pet, Rex is assumed in this example to have been photographed on previous occasions. The picture recognition function 38 may execute the pattern matching application 39 to compare the image of Rex in the viewfinder against one or more references. For example, the references may be accessible stored images. The stored images may be contained in an internal storage medium, such as the memory 90. Alternatively or additionally, accessible stored images may be contained in a removable storage device, or on an external networked storage device. For example, images may be store within the image database 78 located on the networked picture recognition server 75 of FIG. 5. By applying pattern matching to a plurality of references or stored images, Rex may be recognized as a previously photographed subject.

In this example, Rex is not the only potentially recognizable subject. Rex is located at subject 40b, an exemplary physical address of 123 Main Street (which may be any address). Assume for the purposes of the example that the address of 123 Main Street is an apartment complex that includes the user's specific apartment. In other words, the address may be the user's home address. The background also includes another exemplary subject 40c, the Washington Monument. These are examples of static subjects because they stay in a single location.

It will be appreciated by this example how pattern matching may be combined with location data to recognize subjects in the viewfinder. For example, the Washington Monument may be too far such that pattern matching may not have sufficient resolution to distinguish it from other obelisk-type structures that may exist. Referring to the components of the location/orientation assembly 31 (see FIG. 3), the user's GPS location, as determined by the GPS receiver 32, may be used to narrow the subject down to those obelisk-type structures at least within the vicinity of the user's address or location. In addition, compass data from compass 34 may narrow the subject down further to those obelisk-type structures in a given directional line of sight from the user's address or location. The data gathered by the assembly 31 may then be compared to existing location data describing actual locations to provide additional recognition information. For example, the information gathered by the assembly 31 may be compared to information in the location database 79 of the server 75 to aid in recognizing static subjects that may be consistent with the user's location and orientation. The location data may be combined with the pattern matching to perform a more complete recognition analysis. In this manner, the picture recognition function 39 may combine pattern matching with location data analysis to recognize the Washington Monument despite the distance from the user to the monument. Similarly, location data may be used to recognize that the user is at the user's home address, even though only a slight angular view of the building is visible in the viewfinder.

It will also be appreciated that the subject recognition functions may be performed externally to the user's electronic device 10. For example, the recognition functions may be performed in whole or in part by the picture recognition function 79 of server 75. Recognition information may then be transmitted to the user electronic device over the network.

Once one or more subjects in the captured image are recognized, stored images containing the same, similar, or overlapping subjects may be identified to the user, and the user may be provided with access to such identified stored images. FIG. 7B depicts an exemplary graphical user interface 42 for providing user access to the identified stored images. In this example, overlaid on the image depicted in the viewfinder is a listing of the recognized subjects, and an indication of the number of identified stored images that contain each recognized subject. In this example, the graphical user interface informs the user that there exist thirteen stored images containing Rex, two stored images containing the Washington Monument, and four stored images containing the user's home. A visual command line 43 may provide access to the sets of any of the identified stored images.

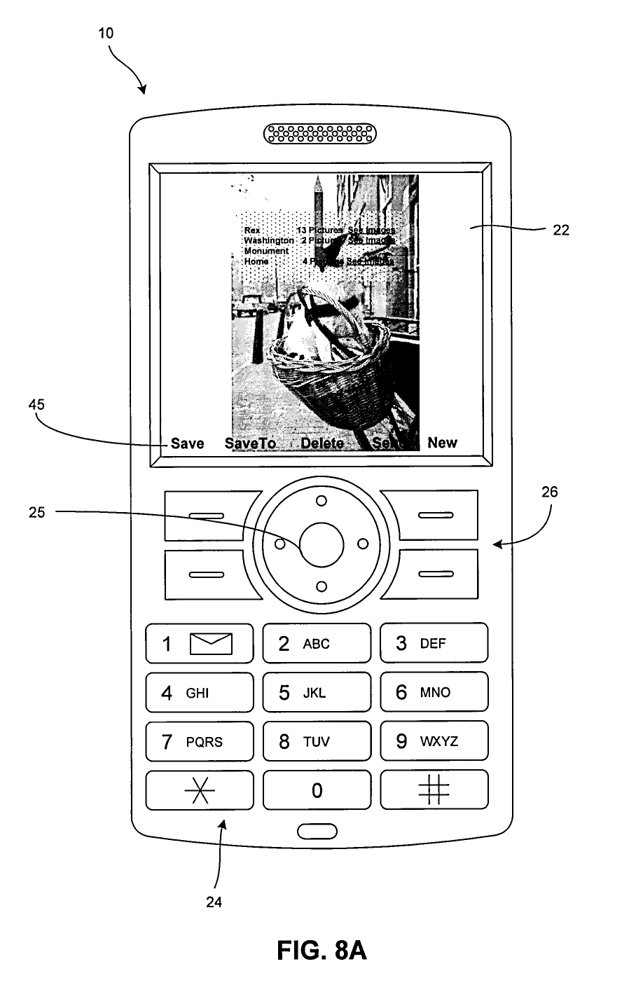

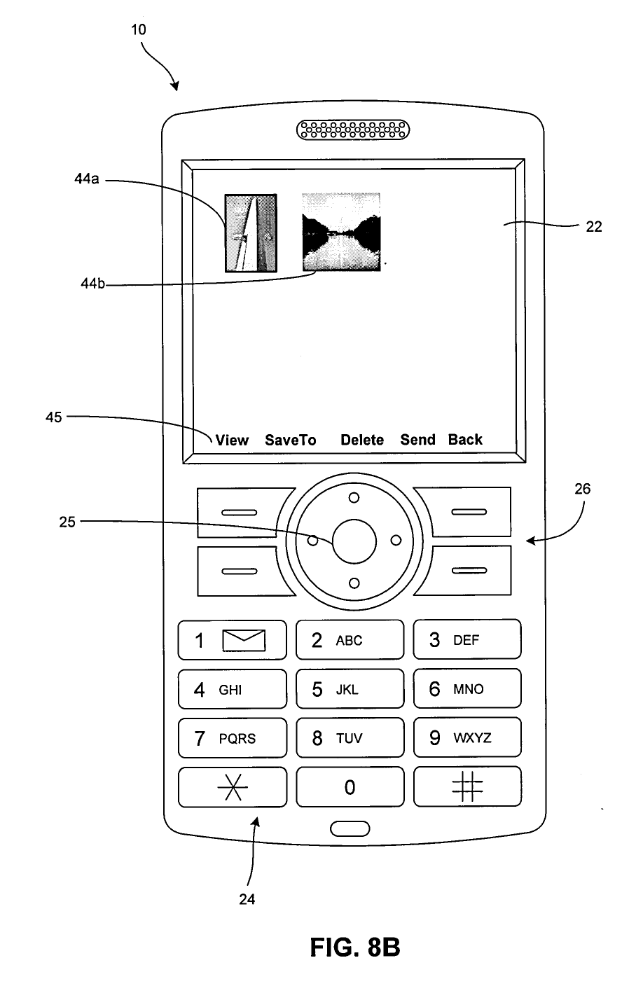

FIG. 8A depicts an example of the viewfinder image of FIG. 7B as it may be seen in the display 22 of electronic device 10. A user may navigate the subject list using one or more buttons 26 on the keypad 24. For example, a user may employ a five-way navigation/select ring 25 to navigate the subject list and select to view a set of related images for a given subject. The subject list information may not be confined to the number of stored images related to each subject, as depicted in the figure. Other information may include dates of the stored images, a ranking or other measurement of the closeness of a match, relative image resolution, and other items that may permit a user to compare to viewfinder image to the related store images. The user also may select various manipulation command functions 45, such as “Save” to photograph and save the viewfinder image to a default location, “Save To” to save the viewfinder image to a selectable file in memory or on an external database, “Delete” to delete the viewfinder image, or “Send” to transmit the viewfinder image to another.

Another manipulation function may be “New”, which would permit the user to create a reference for future recognition and comparisons. For example, if Rex had not been photographed before, the user could select the “New” command and enter Rex as a subject for future recognition. In one embodiment, the subject label entered by the user is tagged and stored as part of the metadata associated with the photograph. The picture recognition function also may incorporate other recognition information into the metadata of the photograph. For example, location, camera orientation, viewing angle, and the like may be incorporated into the metadata of the photograph file, either at the time the picture is taken or by subsequent processing. When done after the photograph is taken, such processing may permit the user to categorize various subjects by the metadata fields to permit later browsing of related images.

It will be appreciated that the above represent examples. Other display and command schemes may be employed.

FIG. 8B depicts an example of the display 22 in a situation in which a user has selected to view the two other stored images of the Washington Monument. In this example, the images are shown as thumbnail items. Either of the two images may be selected, for example, with the navigation ring for more close-up viewing. In this example, a user is considering the first thumbnail image, as shown by the box around first image. The display 22 also may provide selectable additional command options, such as “View” to view the stored image, “Save To” to save the stored image to a particular storage location, “Delete” to delete one of the stored images, “Send” to transmit the stored image, and “Back” to return to the viewfinder display. It will be appreciated that, as before, these are examples, and other display and command schemes may be employed.

Other variations of this example may be devised. For example, the picture recognition function may be performed either before or after a picture is actually taken (converting an image depicted in the viewfinder to a photograph file). Typically, the image of a live or real-time subject captured in the viewfinder may change as the camera is moved. In one embodiment, however, the system may incorporate a “lock on” feature that may freeze the image depicted in the viewfinder by storing the image in a video or image buffer or other transient storage medium prior to creating a photograph file. The viewfinder image, therefore, may remain fixed at least for a time period to permit analysis of the image even if the subjects or the camera move while a user considers the picture recognition results. Furthermore, a user may decide whether to create a photograph file (i.e., take a picture) for more permanent storage in memory based on the picture recognition results. For example, if the user is at a landmark and points the viewfinder at it, the user may be notified of the existence of numerous photographs of the same landmark. The user may then discard the viewfinder image, thereby reducing the likelihood of amassing redundant photographs. Similarly, the user may replace a previously stored photograph with the current viewfinder image by replacing a previously stored photograph with a photograph file corresponding to the current viewfinder image.

The system also need not be used in conjunction with a “live” or contemporaneous image depicted in the viewfinder. Similar operations may be applied to any stored image displayed in the display 22. For example, suppose the photograph of Rex had been taken on some prior occasion, and is now stored in memory or in an external storage device. A user may access and display the image in the display 22, such as when the user would want to show the picture to a friend. The user may then execute the picture recognition function to efficiently identify and obtain access to other pictures of Rex, which may then be shown to the friend. The system, therefore, provides for easy access to images of related subject matter without having to manually navigate a memory system or database. For non-live images, the picture recognition may be simpler and need not include pattern matching and location analysis. As stated above, subject information and descriptive tags may be stored as part of the metadata of the various photographs. For picture recognition involving only stored photographs, picture recognition may include merely a search and comparison for matching metadata subject information.

Referring again to FIG. 3, additional components of the mobile telephone 10 will now be described. For the sake of brevity, generally conventional features of the mobile telephone 10 will not be described in great detail herein.

The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 90, executing applications to allow user interaction with data, displaying video and/or image content associated with the data, outputting audio sounds associated with the data and so forth.

The mobile telephone 10 may include an antenna 94 coupled to a radio circuit 96. The radio circuit 96 includes a radio frequency transmitter and receiver for transmitting and receiving signals via the antenna 94 as is conventional. The mobile telephone 10 further includes a sound signal processing circuit 98 for processing audio signals transmitted by and received from the radio circuit 96. Coupled to the sound processing circuit are a speaker 60 and microphone 62 that enable a user to listen and speak via the mobile telephone 10 as is conventional (see also FIG. 1).

The display 22 may be coupled to the control circuit 30 by a video processing circuit 64 that converts video data to a video signal used to drive the display. The video processing circuit 64 may include any appropriate buffers, decoders, video data processors and so forth. The video data may be generated by the control circuit 30, retrieved from a video file that is stored in the memory 90, derived from an incoming video data stream received by the radio circuit 96 or obtained by any other suitable method.

The mobile telephone 10 also may include a local wireless interface 69, such as an infrared transceiver and/or an RF adaptor (e.g., a Bluetooth adapter), for establishing communication with an accessory, another mobile radio terminal, a computer or another device. For example, the local wireless interface 69 may operatively couple the mobile telephone 10 to a headset assembly (e.g., a PHF device) in an embodiment where the headset assembly has a corresponding wireless interface. The mobile telephone 10 also may include an I/O interface 67 that permits connection to a variety of I/O conventional I/O devices. One such device is a power charger that can be used to charge an internal power supply unit (PSU) 68.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device comprising:
a camera assembly for capturing an image;
a controller configured to perform picture recognition on the captured image to recognize at least one subject within the captured image, and configured to compare the recognized subject from the captured image to a plurality of stored images to identify at least one stored image that contains the at least one recognized subject from the captured image; and
an input interface for receiving an input command to manipulate at least one of the captured image or an identified stored image, wherein the controller executes the received manipulation command.

2. The electronic device of claim 1 further comprising a viewfinder for displaying the captured image.

3. The electronic device of claim 1, wherein the controller is configured to perform picture recognition by applying pattern matching against a reference to recognize one or more subjects in the captured image.

4. The electronic device of claim 3 further comprising a location/orientation assembly for gathering location data, wherein the controller is further configured to perform picture recognition by comparing the gathered location data to location information contained in a location database to recognize a subject in the captured image.

5. The electronic device of claim 4, wherein the location/orientation assembly comprises at least one of a position data receiver, an altimeter, a compass, or an accelerometer.

6. The electronic device of claim 3 further comprising a location/orientation assembly for gathering location data, wherein the controller is further configured to perform picture recognition by comparing the gathered location data to location information contained in metadata of the stored images to recognize a subject in the captured image.

7. The electronic device of claim 1 further comprising a storage device containing the plurality of stored images.

8. The electronic device of claim 1, wherein the manipulation command is at least one of saving the captured image, deleting the captured image or an identified stored image, transmitting the captured image or an identified stored image, or viewing an identified stored image.

9. The electronic device of claim 1, wherein the controller is further configured to incorporate subject information relating to the recognized subject into metadata associated with the captured image, and configured to compare metadata associated with the recognized subject of the captured image to metadata associated with each of the plurality of stored images to identify at least one stored image that contains the recognized subject.

10. A server for communicating with an electronic device having a camera assembly for capturing an image, the server comprising:
an image database containing a plurality of stored images; and
a controller configured to perform picture recognition on the captured image to recognize at least one subject within the captured image, and configured to compare the at least one recognized subject of the captured image to the plurality of stored images to identify at least one stored image that contains a recognized subject;
wherein the server receives a command from a user of the portable electronic device to manipulate at least one of the captured image or an identified stored image, and the controller executes the received manipulation command.

11. The server of claim 10, wherein the controller is configured to perform picture recognition by applying pattern matching against a reference to recognize the subject in the captured image.

12. The server of claim 11, wherein:
the server further comprises a location database containing location information relating to a plurality of locations, wherein the server receives location data from the portable electronic device regarding a user's location; and
the controller is further configured to perform picture recognition by comparing the location data received from the electronic device and location information contained in the location database to recognize the subject in the captured image.

13. The server of claim 10, wherein the controller is further configured to incorporate subject information relating to the recognized subject into metadata associated with the captured image, and configured to compare metadata associated with the recognized subject of the captured image to metadata associated with each of the plurality of stored images to identify at least one stored image that contains the recognized subject.

14. A method of operating a camera function comprising the steps of:
capturing an image;
performing picture recognition to recognize a subject in the captured image;
comparing the recognized subject of the captured image to a plurality of stored images to identify at least one stored image that contains the recognized subject; and
manipulating at least one captured image or an identified stored image.

15. The method claim 14 further comprising displaying the captured image.

16. The method of claim 14, wherein performing picture recognition comprises applying pattern matching to a reference to recognize the subject in the captured image.

17. The method of claim 16, wherein performing picture recognition further comprises gathering location data relating to the captured image and comparing the location data to location information in a location database to recognize the subject in the captured image.

18. The method of claim 14 further comprising incorporating subject information relating to the recognized subject into metadata associated with the captured image, wherein the comparing step includes comparing the metadata associated with the recognized subject of the captured image to metadata associated with each of the plurality of stored images to identify the at least one stored image that contains the recognized subject.

19. The method of claim 14, wherein the manipulating step comprises photographing the captured image by creating a photograph file of the captured image and storing the photograph file.

20. The method of claim 14, wherein the manipulating step comprises at least one of saving the captured image, deleting the captured image or an identified stored image, transmitting the captured image or an identified stored image, or viewing an identified stored image.
